(19) United States
(12) Patent Application Publication
(10) Pub. No.: US 2010/0154204 A1
(43) Pub. Date: Jun. 24, 2010

(54) METHOD FOR FABRICATING FUEL CELL AND ANODE CATALYST LAYER THEREOF

(76) Inventor: Takashi AKIYAMA, Osaka (JP)

Correspondence Address: MCDERMOTT WILL & EMERY LLP, 600 13TH STREET, NW, WASHINGTON, DC, 20005-3096, US

(21) Appl. No.: 12/638,534

(22) Filed: Dec. 15, 2009

(30) Foreign Application Priority Data
Dec. 19, 2008 (JP) 2008-323188

(51) Int. Cl. H01M 8/00; H01M 8/10; H01M 4/88

(52) U.S. Cl. 29/623.1; 502/101

(57) ABSTRACT

The present invention relates to a method for fabricating a fuel cell including a step of producing a unit cell, the step of producing a unit cell including a step of producing at least one unit cell including an anode including an anode catalyst layer containing an anode catalyst, a cathode including a cathode catalyst layer containing a cathode catalyst, and an electrolyte membrane interposed between the anode and the cathode, in which the step of producing a unit cell includes a step (i) of immersing the anode catalyst in an acid-containing solution under the presence of a proton-conductive ion-exchange resin, the proton concentration in the acid-containing solution being 0.1 mol/L or more and 2 mol/L or less.

### FIELD OF THE INVENTION

The present invention relates to improving a fuel cell, and specifically relates to improving an anode catalyst layer thereof.

### BACKGROUND OF THE INVENTION

Fuel cells are classified into: a phosphoric acid type, an alkaline type, a molten carbonate type, a solid oxide type, a solid polymer electrolyte type, and the like, depending on the type of electrolyte used. Among the above, solid polymer electrolyte fuel cells are capable of operating at low temperatures and have high output density, thus gradually being put into practical use as an in-car power source, a household co-generation system power source, and the like.

Fuel cells do not require charging as with secondary batteries and are capable of generating power by only replenishing fuel. Due to the above, fuel cells are recently anticipated as the future power source to enable improved convenience in portable devices such as laptop computers, cell phones, and PDAs. Solid polymer electrolyte fuel cells (hereinafter referred to as PEFCs) with a low operating temperature are the focus of attention as fuel cells used as the power source for such portable devices, and direct oxidation fuel cells are particularly the most anticipated. This is because a direct oxidation fuel cell: enables electric power to be generated by direct oxidation of a liquid fuel at the electrode without requiring the liquid fuel to be reformed into hydrogen, and further, is easy to downsize since a reformer is not necessary therein.

The use of low molecular weight alcohols or ethers is considered as fuel for a direct oxidation fuel cell. Methanol is particularly promising as such candidate, due to enabling enhancement in energy efficiency and output power. That is, a direct methanol fuel cell (hereinafter referred to as DMFC) using methanol as fuel is the most promising candidate among direct oxidation fuel cells.

PEFCs including DMFCs include at least one unit cell which is the basic component. The unit cell is formed by: disposing a pair of catalyst layers, so that each layer faces the other with an electrode membrane in between the two; and further stacking on each catalyst layer at a face opposite of a face in contact with the electrolyte membrane, a conductive water-repellent layer, a gas diffusion layer, and a separator in this order. A stacked body constituted of an electrolyte membrane and a pair of catalyst layers is called CCM (Catalyst Coated Membrane), and a stacked body constituted of an electrolyte membrane sandwiched by an anode and a cathode is called MEA (Membrane Electrode Assembly). An anode and a cathode each include a catalyst layer, a conductive water-repellent layer, and a gas diffusion layer. Fuel is supplied to the anode, and an oxidant such as oxygen is supplied to the cathode.

An anode separator is in contact with the anode, and a cathode separator is in contact with the cathode. The anode separator is provided with a fuel flow channel for supplying fuel to the anode, and the cathode separator is provided with an oxidant flow channel for supplying an oxidant to the cathode.

The reactions at the anode and the cathode of a DMFC are represented by reaction formulas (1) and (2), respectively. Oxygen introduced to the cathode is typically taken in from air.

CH₃\dot{O}H+H₂O→CO₂+6H⁺+6e⁻ (1)

3/2O₂+6H⁺+6e⁻→3H₂O (2)

Voltage for power generation in a unit cell constituting a fuel cell is 1 V or less, and it is difficult to drive a device by voltage produced in a unit cell. Due to the above, it is typical to obtain high voltage by stacking a plurality of unit cells in series. Such stacked body of unit cells is called a stack.

The catalyst layer of the anode contains an anode catalyst, and the catalyst layer of the cathode contains a cathode catalyst. In a DMFC, an alloy of platinum and ruthenium is typically used as the anode catalyst, and platinum is typically used as the cathode catalyst. Further, the catalyst is fine-grained to increase the active surface area thereof. In this case, catalyst fine particles are often carried on a carrier such as carbon black.

With respect to the anode catalyst, it is known that a platinum-ruthenium alloy whose atomic ratio between platinum and ruthenium is approximately 1:1, is the most active with excellent performance.

However, conventionally-used electrode catalysts are known to degrade in performance due to: long-term use of a DMFC; unusual operations in a DMFC such as stopping during activation; usage environment change of a DMFC; and the like. This mechanism will be explained in the following. Platinum, an element constituting the anode catalyst, is relatively stable even under a strongly-acidic environment, when within a potential range of 0 to 0.5 V (vs. standard hydrogen electrode) to which the anode is exposed. On the other hand, ruthenium is known to dissolve at approximately 0.45 V. The dissolution (leaching) of ruthenium is known to become less as the formation of platinum-ruthenium alloy progresses. However, in a conventionally-used anode catalyst containing ruthenium, it is not yet possible to completely prevent the dissolution of ruthenium. The leaching of ruthenium causes change in the atomic ratio between platinum and ruthenium in the anode catalyst, thus causing performance degradation of the anode catalyst.

Further, ruthenium ions that have leached reach the cathode after passing through the electrolyte membrane, thus causing degradation in the oxygen reduction activity of the cathode catalyst. As a result, power generation performance degrades. Such phenomenon of ruthenium transferring from the anode to the cathode is called ruthenium crossover, and such phenomenon of the cathode catalyst degrading in performance due to ruthenium getting mixed with the cathode catalyst is called ruthenium poisoning.

DOE HYDROGEN PROGRAM FY2005 PROGRESS REPORT (Document 1) proposes three methods for reducing ruthenium crossovers. The first method is to perform acid treatment on the anode catalyst. The second method is to perform acid treatment on the electrolyte membrane on which the anode catalyst layer is formed. The third method is to perform heat treatment on the anode catalyst layer, when the anode catalyst layer is bonded to the electrolyte membrane by hot-pressing. The first and second methods are attempts to reduce the leaching amount of ruthenium after the DMFC is assembled, by immersing the anode catalyst in acid to remove in advance ruthenium prone to dissolution.

Document 1 proposes removing ruthenium prone to dissolution by treating the anode catalyst with acid, but does not disclose any specific procedures or methods for treatment. In addition, in the case of dissolving metal by acid, it is typically effective to use acid with high acid strength, that is, with a high proton concentration. However, there are risks in the safety of workers regarding the use of acid with high acid strength, and there is concern that production costs would rise due to taking safety measures. Further, in the case of using acid with high concentration, anions which are counterions to protons would be present in large amounts on the catalyst surface or in the catalyst layer. Due to the above, it would be difficult to sufficiently remove the counterions. In the case where sufficient removal of the counterions is not possible, there is a possibility of a decline in catalyst activity due to impurity incorporation or a functional decline of the electrode.

The object of the present invention is to provide a fuel cell with high power generation performance and suppressed performance degradation, thus solving the problem mentioned above.

### BRIEF SUMMARY OF THE INVENTION

The present invention relates to a method for fabricating a fuel cell including a step of producing a unit cell, the step of producing a unit cell including a step of producing at least one unit cell including an anode including an anode catalyst layer containing an anode catalyst, a cathode including a cathode catalyst layer containing a cathode catalyst, and an electrolyte membrane interposed between the anode and the cathode, in which the step of producing a unit cell includes a step (i) of immersing the anode catalyst in an acid-containing solution under the presence of a proton-conductive ion-exchange resin, the proton concentration in the acid-containing solution being 0.1 mol/L or more and 2 mol/L or less.

By the proton concentration in the acid-containing solution is meant the proton concentration in the acid-containing solution before the immersion of the anode catalyst and the ion-exchange resin therein.

Further, the present invention relates to a method for fabricating an anode catalyst layer containing an anode catalyst, including a step (i) of immersing the anode catalyst in an acid-containing solution under the presence of a proton-conductive ion-exchange resin, the proton concentration in the acid-containing solution being 0.1 mol/L or more and 2 mol/L or less.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWING

FIG. 1 is a vertical sectional view illustrating an example of a constitution of a direct methanol fuel cell containing an anode catalyst treated by using a method according to one embodiment of the present invention.

### DETAILED DESCRIPTION OF THE INVENTION

Preferred embodiments of the present invention will be explained in the following.

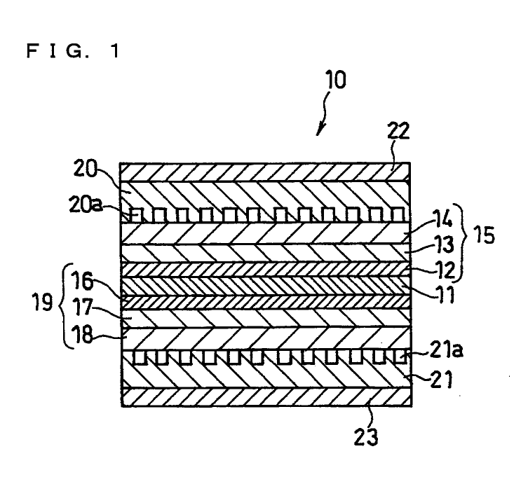

FIG. 1 illustrates an example of a constitution of a direct methanol fuel cell (DMFC) produced by using a method of the present invention. The fuel cell in FIG. 1 is constituted of one unit cell 10. The unit cell 10 includes an anode 15 including an anode catalyst layer containing an anode catalyst, a cathode 19 including a cathode catalyst layer containing a cathode catalyst, and an electrolyte membrane 11 interposed between the anode 15 and the cathode 19. Specifically, in the unit cell 10, the anode 15 includes: an anode catalyst layer 12 in contact with the electrolyte membrane 11; an anode conductive water-repellent layer 13 provided on the anode catalyst layer 12; and an anode gas diffusion layer 14 provided on the anode conductive water-repellent layer 13. The cathode 19 includes: a cathode catalyst layer 16 in contact with the electrolyte membrane 11; a cathode conductive water-repellent layer 17 provided on the cathode catalyst layer 16; and a cathode gas diffusion layer 18 provided on the cathode conductive water-repellent layer 17.

An MEA constituted of the electrolyte membrane 11, the anode 15, and the cathode 19, is sandwiched between an anode separator 20 and a cathode separator 21. On a face of the anode separator 20 in contact with the anode 15, a fuel flow channel 20a is provided for supplying fuel to the anode 15. On a face of the cathode separator 21 in contact with the cathode 19, an oxidant flow channel 21a is provided for supplying an oxidant to the cathode 19.

A membrane made of a proton-conductive electrolyte is satisfactory as the electrolyte membrane 11. For example, a membrane made of perfluorocarbonsulfonic acid polymer (for example, Nafion® manufactured by E. I. du Pont de Nemours and Company), a composite membrane including an inorganic membrane and an organic membrane, a composite membrane including a plurality of organic membranes, a membrane made of hydrocarbon polymer not containing fluorine, or the like can be used. The electrolyte membrane 11 preferably has an effect of reducing crossovers of methanol as fuel.

The anode conductive water-repellent layer 13 and the cathode conductive water-repellent layer 17 (hereinafter collectively referred to simply as conductive water-repellent layer) can be produced as follows, for example. An ink is prepared by stirring and mixing in a dispersant: a material capable of forming a conductive porous layer such as carbon black (such as furnace black and acetylene black), a graphite powder, and a porous metallic powder; and a water-repellent material (for example, a fluorocarbon resin such as polytetrafluoroethylene (PTFE)). The ink is applied onto a smooth-surfaced sheet (such as a PTFE sheet) by, for example, a doctor blade, and then dried. Thus obtained is the conductive water-repellent layer.

A carbon paper, a carbon cloth, or a carbon non-woven fabric each made of carbon fiber is typically used as the anode gas diffusion layer 14 and the cathode gas diffusion layer 18.

The conductive water-repellent layer may be formed directly on the gas diffusion layer.

The anode separator 20 can be obtained by forming the fuel flow channel 20a on a plate-like material made of a carbon material such as graphite, by cutting or the like. Alternatively, the anode separator 20 can be obtained also by metal molding that uses injection molding, compression molding, or the like. The cathode separator 21 can be obtained in the same manner.

In the unit cell 10 of FIG. 1, end plates 22 and 23 are disposed on outer sides of the anode separator 20 and the cathode separator 21, respectively. Tightening the two end plates 22 and 23 by using bolts and springs (not illustrated) enables tightening pressure to be applied to the MEA and the two separators 20 and 21.

In the MEA, bonding characteristics between components are high, since each component is bonded by, for example, hot-pressing or the like. On the other hand, bonding characteristics between the MEA and the respective separators are not particularly high, since the MEA and the respective separators 20 and 21 are only in contact with one another. Therefore, pressure is applied to the MEA and the separators 20 and 21 in the stacking direction to tighten the whole for reducing contact resistance between the MEA and the respective separators 20 and 21. The above also applies in the case of tightening a stacked body constituted of a plurality of unit cells.

In the unit cell 10, a CCM constituted of the electrolyte membrane 11, the anode catalyst layer 12, and the cathode catalyst layer 16 serves to generate power. In the anode 15, the anode conductive water-repellent layer 13 and the anode gas diffusion layer 14 serve to uniformly disperse supplied fuel and to smoothly discharge carbon dioxide as a product. Likewise, in the cathode 19, the cathode conductive water-repellent layer 17 and the cathode gas diffusion layer 18 serve to uniformly disperse supplied oxide and to smoothly discharge water as a product.

The anode catalyst layer 12 contains an anode catalyst for promoting the electrode reaction represented by the formula (1) mentioned above and a polymer electrolyte for securing ionic conductivity for the anode catalyst layer 12. Likewise, the cathode catalyst layer 16 contains a cathode catalyst for promoting the electrode reaction represented by the formula (2) mentioned above and a polymer electrolyte for securing ionic conductivity for the cathode catalyst layer 16.

Currently, the electrolyte membrane 11 for a DMFC mainly in development is a proton-conductive type. Thus, the polymer electrolyte used in the anode catalyst layer 12 and the cathode catalyst layer 16 is also preferably a proton-conductive ion-exchange resin.

As mentioned above, an alloy of platinum and ruthenium is typically used as the anode catalyst contained in the anode catalyst layer 12, and the atomic ratio of platinum and ruthenium is preferably 1:1. In fact, the alloying degree of platinum and ruthenium varies, and the alloy is partially a mixture of platinum and ruthenium in most cases.

Alternatively, the anode catalyst may be a mixture of an elementary platinum and an elementary ruthenium.

Further alternatively, a mixture of an elementary platinum, a platinum-ruthenium alloy, and a ruthenium oxide may be used as the anode catalyst. The mixture of an elementary platinum, a platinum-ruthenium alloy, and a ruthenium oxide may also be a mixture of an elementary platinum and a platinum-ruthenium alloy, a part of which is a ruthenium oxide resulting from oxidation.

An elementary platinum or an alloy of platinum and a transition metal is used as the cathode catalyst contained in the cathode catalyst layer 16. Cobalt, iron, or the like is used as the transition metal.

The anode catalyst and the cathode catalyst may be used in the form of a fine powder, or may be used in the state of being carried on an electronically-conductive material such as a carbon black powder.

The catalyst layer (the anode catalyst layer and the cathode catalyst layer) can be produced by using a method known in the art. Specifically, first, an ink is prepared by mixing and dispersing in water, an organic solvent, or a mixed solvent of water and an inorganic solvent, a dispersion liquid made by dispersing a catalyst powder and a polymer electrolyte in a predetermined dispersion medium. Next, the ink is applied to the electrolyte membrane and dried, thus enabling the formation of a catalyst layer. Alternatively, a catalyst layer obtained by applying the ink onto a resin sheet followed by drying may be transferred onto an electrolyte membrane by hot-pressing.

A spraying method, a screen printing method, and the like can be given as methods for applying the ink to the electrolyte membrane or the resin sheet. In addition, the ink can be applied by a squeegee method in which the ink is applied onto the electrolyte membrane or the resin sheet at predetermined intervals.

As mentioned above, in the case where the anode catalyst contains ruthenium, degradation of the anode catalyst occurs due to ruthenium leaching therefrom, and further, degradation of the cathode catalyst occurs due to the leached ruthenium transferring to the cathode. Therefore, the anode catalyst is treated in advance to prevent ruthenium from leaching therefrom after the fuel cell is assembled.

Specifically, a method for fabricating a fuel cell of the present invention includes a step of producing a unit cell including an anode including an anode catalyst layer containing an anode catalyst, a cathode including a cathode catalyst layer containing a cathode catalyst, and an electrolyte membrane interposed between the anode and the cathode, in which the step of producing a unit cell includes a step (i) of immersing the anode catalyst in an acid-containing solution under the presence of a proton-conductive ion-exchange resin. The proton concentration in the acid-containing solution is 0.1 mol/L or more and 2 mol/L or less. That is, in the present invention, the anode catalyst is immersed in an acid solution with a proton concentration of 0.1 mol/L or more and 2 mol/L or less under the presence of a proton-conductive ion-exchange resin, and thus treated. The step (i) may be conducted before or after the formation of the anode catalyst layer. The fuel cell produced includes at least one unit cell.

### Embodiment 1

In the present embodiment, the case of conducting the step (i) before the formation of the anode catalyst layer will be explained.

In the present embodiment, the step (i) includes steps of:

(i-A) mixing the anode catalyst and the proton-conductive ion-exchange resin with the acid-containing solution; and

(i-B) filtering and removing solids from the mixture obtained in the step (i-A). The concentration of protons contained in the acid-contained solution is 0.1 mol/L or more and 2 mol/L or less.

In the step (i-A), the anode catalyst and the proton-conductive ion-exchange resin may be mixed directly with the acid-containing solution. Alternatively, an ink containing the anode catalyst and the proton-conductive ion-exchange resin may be mixed with the acid-containing solution. In either case, the solids obtained in the step (i-B) are mixtures of the anode catalyst and the ion-exchange resin.

In the step (i-A), there is preferably a larger excess of the acid-containing solution compared to the ink, in the case where the ink containing the anode catalyst and the proton-conductive ion-exchange resin is mixed with the acid-containing solution. That is, the amount of the acid-containing solution is preferably made to be in a larger excess, compared to the amount of the anode catalyst.

For example, the ratio of the weight of the acid-containing solution relative to the weight of the ink is preferably made to be 16 or more, although the above depends on the respective types of the anode catalyst and the acid-containing solution. Specifically, the amount of a solution having a 2M proton concentration is preferably made to be 8 g or more per 50 mg of the anode catalyst. This is because the proton concentration in the mixture of the ink and the acid-containing solution is considered to stabilize, and the dissolution of ruthenium from the anode catalyst is thus considered to progress quickly. In this case, the proton concentration in the mixture of the ink and the acid-containing solution is considered to be within the range between about 0.1 mol/L or more to 2 mol/L or less.

In the present embodiment, an anode catalyst layer is produced by using the solids that are filtered and removed. As the above, the anode catalyst layer can be produced by preparing an ink by re-dispersing the solids in a predetermined dispersion medium and then applying the obtained ink to the electrolyte membrane, followed by drying. Alternatively, the anode catalyst layer obtained by applying the obtained ink onto a resin sheet followed by drying may be transferred to the electrolyte membrane by hot-pressing.

Alternatively, the anode catalyst layer may be formed on the electrolyte membrane by uniformly applying and then directly hot-pressing the obtained solids onto the electrolyte membrane.

In the present embodiment, acid strength of the acid-containing solution can be secured to some extent by making the proton concentration therein be 0.1 mol/L or more and 2 mol/L or less. Further including the proton-conductive ion-exchange resin enables protons to be more easily released near the anode catalyst. Due to the above, acid strength increases near the anode catalyst. As a result, it is considered that ruthenium contained in the anode catalyst can be efficiently removed therefrom.

If the proton concentration in the acid-containing solution is less than 0.1 mol/L, it may be difficult to efficiently remove ruthenium contained in the anode catalyst therefrom. If the proton concentration is more than 2 mol/L, there are cases where it would be difficult to secure safety during work.

The amount of the proton-conductive ion-exchange resin mixed with the anode catalyst is adjusted as appropriate, depending on the amount of the anode catalyst. If the amount of the proton-conductive ion-exchange resin is more than the amount of the anode catalyst, the amount of the ion-exchange resin present in the solids after filtration and removal may surpass the optimum amount in terms of power generation characteristics, thus making a proper composition ratio between the catalyst and the ion-exchange resin unobtainable.

For example, the amount of the ion-exchange resin can be made 0.1 g or more per 1 g of the anode catalyst. The upper limit for the amount of the ion-exchange resin is adjusted as appropriate, depending on the amount of the anode catalyst.

However, there are cases where the ratio between the anode catalyst and the ion-exchange resin in the solids obtained by the step (i) does not necessarily correspond with the composition ratio of when an electrode with the best performance is obtained. Thus, the anode catalyst layer is preferably produced by adding as required the necessary amount of the ion-exchange resin to the solids or the dispersion liquid containing the solids, and using the mixture thus obtained.

The time for immersing the anode catalyst in the acid-containing solution is preferably 6 hours or more at room temperature. If the immersion time is 6 hours or more, the acid would be sufficiently permeated in the micropores of the anode catalyst particles to leach ruthenium out, and the leaching of ruthenium can converge sufficiently, although these would depend on the physical property of the anode catalyst. Here, by room temperature is meant that within the range of 10 to 50° C.

An inorganic acid such as sulfuric acid, nitric acid, and hydrochloric acid and an organic acid having no more than 2 carbon atoms can be used as acid contained in the solution mentioned above. Formic acid, acetic acid, and the like can be given as the organic acid having no more than 2 carbon atoms.

In the fabricating method of the present embodiment, a step (ii) of removing from the solids filtered and removed, anions originating from the acid is preferably included after the step (i-B). Particularly, in the case where an inorganic acid such as sulfuric acid and nitric acid is used as the acid, the step (ii) of removing anions originating from the acid from the solids preferably includes a water washing step.

Typically, there is a possibility that anions constituting an inorganic acid such as sulfuric acid, nitric acid, and hydrochloric acid reduce the catalyst activity of the anode catalyst by adsorbing on a surface of the anode catalyst or by the like. Therefore, anions are preferably removed as much as possible from the solids filtered and removed.

Specifically, the anions can be removed by repeating a step of immersing the solids in ion-exchange water for several hours and then filtrating and removing the solids several times.

In the case of using an inorganic acid as the acid, sulfuric acid is preferably used. Compared to acid containing a halogen element such as hydrochloric acid, sulfuric acid has a lesser degree of catalyst activity reduction in the case where anions (sulfuric acid ions) remain, and is easily obtainable and with lower cost.

In addition, sulfuric acid is a bivalent acid with a dissociation degree of nearly 1. Due to the above, in the case of using sulfuric acid as the acid, an aqueous solution of dilute sulfuric acid with a concentration of 0.05 mol/L or more and 1 mol/L or less can be used as the acid-containing solution with a proton concentration of 0.1 mol/L or more and 2 mol/L of less. In the case of using sulfuric acid, since an aqueous solution of dilute sulfuric acid can be used as the acid-containing solution, thus not requiring the use of concentrated sulfuric acid, risk reduction is possible in the case where the acid-containing solution comes in contact with the human body. Further, the amount of residual sulfuric acid ions also can be reduced. Thus, the water washing step can also be made relatively simple.

In particular, the acid is preferably an organic acid having no more than 2 carbon atoms such as formic acid and acetic acid. Removal of anions is possible by oxidation induced by gently drying the solids after treatment with a solution containing an organic acid having no more than 2 carbon atoms, and making oxygen to gently come in contact with the organic acid. Alternatively, catalyzed oxidation of an organic acid having no more than 2 carbon atoms is possible by forming the anode catalyst layer using the solids, and then supplying oxygen to the anode catalyst layer. As the above, in the case of using an organic acid having no more than 2 carbon atoms, the step of removing anions may be omitted, since the problem of anions remaining rarely occurs.

However, if an organic acid having no more than 2 carbon atoms is suddenly made to come in contact with oxygen, there may be thermal damage to the ion-exchange resin due to rapid generation of heat caused by an oxidation reaction.

Among organic acids having no more than 2 carbon atoms, formic acid is particularly preferable due to having a high dissociation degree.

In the present embodiment, when the anode catalyst after undergoing the step (i) or the step (ii) is immersed in a mixture containing: 0.1 g or more of the proton-conductive ion-exchange resin per 1 g of the anode catalyst; and protons originating from the acid used in the step (i) at a concentration of 0.1 mol/L or more and 2 mol/L or less, the leaching amount per hour of ruthenium from the anode catalyst can be made 1 μg/h or less per 1 mg of the anode catalyst.

That is, when the anode catalyst after undergoing the step (i) or the step (ii) is immersed in a predetermined mixture, the leaching amount per hour of ruthenium from the anode catalyst can be made 1 μg/h or less per 1 mg of the anode catalyst. The predetermined mixture contains the acid-containing solution and the ion-exchange resin each used in the step (i). The amount of the ion-exchange resin is 0.1 g or more per 1 g of the anode catalyst.

As mentioned above, the amount of the ion-exchange resin mixed with the anode catalyst (that is, the amount of the ion-exchange resin contained in the anode catalyst layer) is preferably 0.1 g or more per 1 g of the anode catalyst. Due to the above, the amount of the ion-exchange resin contained in the predetermined mixture is also preferably 0.1 g or more per 1 g of the anode catalyst.

The proportion of the amount of the ion-exchange resin contained in the anode catalyst ink or the anode catalyst layer may be different from or the same as the proportion of the amount of ion-exchanged resin contained in the predetermined mixture.

In the present embodiment, an anode catalyst whose leaching amount of ruthenium therefrom is 1 μg/h or less per 1 mg of the anode catalyst can be obtained. By using such an anode catalyst, a fuel cell with high power generation performance and suppressed performance degradation can be obtained.

In the present embodiment, a fuel cell can be produced by steps of:

(iii) forming an anode catalyst layer by using the solids obtained in the step (i) or the step (ii); and

(iv) producing by using the anode catalyst layer, a fuel cell including a unit, cell including an anode, an electrolyte membrane, and a cathode. Here, the step (iv) can include a method known in the art.

### Embodiment 2

In the present embodiment, the case where the step (i) includes a step of forming the anode catalyst layer, that is, the case where the step (i) is conducted after the formation of the anode catalyst layer will be explained.

In the present embodiment, first, an anode catalyst layer is formed. The anode catalyst layer can be produced as mentioned above. Specifically, a method for producing an anode catalyst layer includes steps of:

(I-a) preparing a catalyst ink containing an anode catalyst and a proton-conductive ion-exchange resin; and

(I-b) producing an anode catalyst layer by using the catalyst ink.

In the present embodiment, the step (i) includes a step (I-c) in which the anode catalyst layer produced as mentioned above is immersed in an acid-containing solution. For example, the anode catalyst layer can be immersed in the acid-containing solution by immersing a CCM in the acid-containing solution, the CCM constituted of an electrolyte membrane with an anode catalyst layer and a cathode catalyst layer formed respectively thereon. At this time, if ruthenium ions leached from the anode catalyst are taken in the cathode catalyst layer, there is a possibility of the ruthenium ions being deposited on or near the cathode catalyst, thus resulting in the reduction of cathode catalyst activity. Thus, the electrolyte membrane on which only the anode catalyst layer is formed is preferably immersed in the acid-containing solution.

Alternatively, the anode catalyst layer may be immersed in the acid-containing solution by making the CCM float on a surface thereof, so that a face of the electrolyte membrane on which the anode catalyst layer is formed is in contact therewith.

The formation of the anode catalyst layer on the electrolyte membrane can be conducted as mentioned above.

In the present embodiment also, the proton concentration in the acid-containing solution is 0.1 mol/L or more and 2 mol/L or less. This is due to the same reason as for Embodiment 1.

In the present embodiment also, the time for immersing the anode catalyst layer in the acid-containing solution is preferably 6 hours or more at room temperature, as in Embodiment 1.

The amount of the proton-conductive ion-exchange resin contained in the anode catalyst layer is adjusted as appropriate depending on the amount of the anode catalyst, as in Embodiment 1. For example, the amount of the ion-exchange resin is preferably 0.1 g or more per 1 g of the anode catalyst.

As in Embodiment 1, the acid may be an inorganic acid such as sulfuric acid, nitric acid, and hydrochloric acid or may be an organic acid having no more than 2 carbon atoms. Further, the acid is preferably sulfuric acid in the case the acid is an inorganic acid.

The anode catalyst layer which has undergone treatment in the step (I-c) may undergo a step (II) of removing anions originating from the acid. In the case where the acid is an inorganic acid such as sulfuric acid, the step (II) of removing anions originating from the acid preferably includes a water washing step. Specifically, anions originating from the acid and contained in the anode catalyst layer can be removed by, for example, immersing the anode catalyst layer in ion-exchanged water for several hours. The step of immersing the anode catalyst layer in ion-exchanged water is preferably conducted several times, with ion-exchanged water exchanged each time.

An organic acid having no more than 2 carbon atoms is preferable as the acid, as in Embodiment 1. Further, formic acid is particularly preferable as the organic acid having no more than 2 carbon atoms.

In the present embodiment also, when the anode catalyst layer after undergoing the step (I-c) or the step (II) is immersed in a mixture containing: 0.1 g or more of the proton-conductive ion-exchange resin per 1 g of the anode catalyst; and protons originating from the acid used in the step (i) at a concentration of 0.1 mol/L or more and 2 mol/L or less, the leaching amount per hour of ruthenium from the anode catalyst can be made 1 μg/h or less per 1 mg of the anode catalyst.

That is, when the anode catalyst layer after undergoing the step (I-c) or the step (II) is immersed in a predetermined mixture, the leaching amount per hour of ruthenium from the anode catalyst can be made 1 μg/h or less per 1 mg of the anode catalyst. The predetermined mixture contains the acid-containing solution and the ion-exchange resin each used in the step (I-c). The amount of the ion-exchange resin is 0.1 g or more per 1 g of the anode catalyst.

In the present embodiment, a fuel cell can be produced by

a step (III) of producing a fuel cell including a unit cell including an anode, an electrolyte membrane, and a cathode, by using the anode catalyst layer that have undergone the step (I-c) or the step (II). Here, the step (III) can include a method known in the art, as in Embodiment 1.

In Embodiments 1 and 2 mentioned above, the proton-conductive ion-exchange resin preferably contains a perfluorocarbonsulfonic acid polymer. A perfluorocarbonsulfonic acid polymer has high proton conductivity. Thus, by having a perfluorocarbonsulfonic acid polymer contained in the anode catalyst layer, resistance to ionic conductivity is reduced and as a result, high power generation performance can be obtained. The cathode catalyst layer may also contain a perfluorocarbonsulfonic acid polymer as a polymer electrolyte.

In another preferable embodiment of the present invention, the step of producing the anode catalyst layer may include a step of treating the anode catalyst as in Embodiment 1 or a step of treating the anode catalyst layer as in Embodiment 2. That is, the step of producing the anode catalyst layer may include the step (i) mentioned above.

As the above, according to the present invention, leaching of ruthenium from the anode catalyst can be reduced after the fuel cell has been assembled, since ruthenium prone to leaching is removed from the anode catalyst in advance. Thus, the present invention is capable of providing a fuel cell that can exhibit excellent power generation performance for a long period of time. That is, the present invention is capable of providing a fuel cell with high power generation performance and suppressed performance degradation.

### EXAMPLES

In the following, the present invention will be explained with reference to examples. However, it should be noted that the present invention is not limited to the following examples.

### Example 1

A platinum-ruthenium alloy was used at an atomic ratio of 1:1 as an anode catalyst. Particles of the platinum-ruthenium alloy were made to be carried on conductive carbon particles each having an average primary particle size of 30 nm. The proportion of the platinum-ruthenium alloy amount relative to the total amount of the platinum-ruthenium alloy and the carbon particles was 50 wt %.

10 g of the conductive carbon particles carrying the platinum-ruthenium alloy, 100 g of a dispersion containing 5% of Nafion (trade name) manufactured by E. I. du Pont de Nemours and Company as a proton-conductive ion-exchange resin, and a proper amount of water were mixed. The obtained mixture was defoamed to obtain a first anode catalyst ink. The respective amounts of the anode catalyst and the proton-conductive ion-exchange resin were 5 g, causing the first anode catalyst ink to therefore contain 1 g of the ion-exchange resin per 1 g of the anode catalyst.

The first anode catalyst ink and a 1 M aqueous solution of sulfuric acid were mixed, so as to make the amount of the aqueous solution of sulfuric acid be 8 g per 50 mg of the anode catalyst. The obtained mixture was allowed to stand for 18 hours. The proton concentration in the 1 M aqueous solution of sulfuric acid is considered to be 2 mol/L. The pH of the aqueous solution of sulfuric acid should be about −0.3. However, such range was unable to be measured by a commercially available pH meter, and the only fact confirmed was that the pH of the aqueous solution of sulfuric acid was 0 or less.

The mixture after standing was filtered by using a membrane filter with a mesh size of 0.2 μm and a suction pump.

Next, the obtained solids were washed with water. Specifically, the solids obtained by filtration were immersed in ion-exchanged water and stirred for 4 hours, thus being washed with water. After being washed with water, the solids were filtered again. This step was repeated 3 times.

Subsequently, the solids were dispersed in an aqueous ethanol solution to prepare a second anode catalyst ink. The obtained second anode catalyst ink was sprayed to an electrolyte membrane by using an air brush. At this time, the electrolyte membrane was maintained at 60° C. Due to the above, the second anode catalyst ink gradually dried during application, and an anode catalyst layer was thus formed. The thickness of the anode catalyst layer was 30 μm. Nafion® 117 (thickness of 178 μm) was used as the electrolyte membrane.

An elementary platinum was used as a cathode catalyst. Particles of the cathode catalyst were made to be carried on conductive carbon particles each having an average primary particle size of 30 nm. The proportion of the cathode catalyst amount relative to the total amount of the cathode catalyst and the conductive carbon particles was 50 wt %.

The conductive carbon particles carrying the elementary platinum, a dispersion containing a proton-conductive ion-exchange resin (Nafion® manufactured by E. I. du pont de Nemours and Company), and a proper amount of water were mixed. The obtained mixture was defoamed to obtain a cathode catalyst ink. The amount of the ion-exchange resin was 0.3 g per 1 g of the conductive carbon particles carrying the elementary platinum.

The obtained cathode catalyst ink was spray-applied to a face of the electrolyte membrane opposite of a face on which the anode catalyst layer was formed, thus forming a cathode catalyst layer. Thus obtained was a CCM.

Carbon Paper TGP-H-090 (manufactured by Toray Industries, Inc. under such trade name) as a substrate was immersed for 1 minute in PTFE dispersion D-1 (manufactured by Daikin Industries, Ltd. under such trade name) diluted to a desired concentration. Subsequently, the carbon paper was dried in a hot air drier at 100° C., and then subjected to a 2-hour baking treatment in an electric furnace at 270° C. Thus obtained was an anode gas diffusion layer with a 10 wt % PTFE content.

AvCarb 1071HCB (manufactured by Ballard Material Products, Inc. under such trade name) as a substrate was allowed to stand in mixed gas of helium gas and fluorine gas with a fluorine gas content of 0.1 mol %, for 10 minutes at room temperature. Thus obtained was a cathode gas diffusion layer in which a surface of carbon fiber constituting the substrate was fluorinated.

A conductive water-repellent layer was formed on one surface of the anode gas diffusion layer as below. An acetylene black powder and PTFE dispersion D-1 (manufactured by Daikin Industries, Ltd. under such trade name) were mixed to obtain an ink. The PTFE content in the obtained ink was 10 wt %.

The obtained ink was applied to one face of the anode gas diffusion layer by doctor blading, and then dried in a constant temperature chamber at 100° C. Next, the dried ink was baked for 2 hours in an electric furnace at 270° C., thus removing surfactants contained in the ink. Thus formed on the surface of the anode gas diffusion layer was a conductive water-repellent layer.

A conductive water-repellent layer was formed on one face of the cathode gas diffusion layer in the same manner as mentioned above.

The conductive water-repellent layer of the anode gas diffusion layer was disposed so as to be in contact with the anode catalyst layer, and the conductive water-repellent layer of the cathode gas diffusion layer was disposed so as to be in contact with the cathode catalyst layer. The obtained stacked body was hot-pressed with a hot-pressing device, and the catalyst layers and the gas diffusion layers were thus bonded together. Thus obtained was an MEA. Hot-pressing was conducted for 1 minute at a temperature of 125° C. and a pressure of 5 MPa.

A graphite plate having a thickness of 2 mm was used as an anode separator and a cathode separator, respectively. Provided on one face of the respective graphite plates by cutting, was a fuel flow channel or an oxidant flow channel each with a vertical cross section measuring 1 mm×1 mm. A serpentine-type channel was used as the fuel flow channel and the oxidant flow channel, so that there is an even and meandering flow created on the entire power generation area when the fuel cell is assembled.

The anode separator and the cathode separator were disposed, so that a face of the anode separator provided with the fuel flow channel was in contact with the anode gas diffusion layer, and a face of the cathode separator provided with the oxidant flow channel was in contact with the cathode gas diffusion layer. Thus obtained was a stacked body in which the MEA was sandwiched between the anode separator and the cathode separator.

The stacked body was further sandwiched between two end plates, each made of a stainless steel plate having a thickness of 1 cm. The two end plates were each disposed so as to be in contact with the anode separator and the cathode separator, respectively. Current collector plates made of a copper plate having a thickness of 2 mm with a gold-plated surface were disposed between one end plate and the anode separator and between the other end plate and the cathode separator, respectively. The current collector plates were connected to an electronic load device.

The two end plates were tightened and applied with pressure by using bolts, nuts, and springs, and a direct methanol fuel cell (DMFC) made of a unit cell was thus produced. The obtained DMFC was designated as cell “A”.

### Example 2

A first anode cathode ink was prepared in the same manner as Example 1, except for making 1:0.5 be the weight ratio between the anode catalyst and the ion-exchange resin. The obtained first anode catalyst ink contained 0.5 g of the ion-exchange resin per 1 g of the anode catalyst.

An anode catalyst layer was formed on an electrolyte membrane in the same manner as Example 1, by using the first anode catalyst ink. The obtained electrolyte membrane on which only the anode catalyst layer was formed, was allowed to stand in a 1 M aqueous solution of sulfuric acid for 18 hours. Subsequently, the electrolyte membrane was rinsed with ion-exchanged water. Specifically, the electrolyte membrane was subjected to a step of immersing the electrolyte membrane in ion-exchanged water for 4 hours and then exchanging ion-exchanged water 3 times.

Next, the electrolyte membrane on which only the anode catalyst layer was formed was dried at room temperature, and an MEA was produced in the same manner as Example 1 by using the dried electrolyte membrane, and producing a DMFC. The obtained DMFC was designated as cell “B”.

### Example 3

The first anode catalyst ink produced in Example 1 and a 5 M aqueous solution of formic acid were mixed, so that the amount of the aqueous solution of formic acid was 50 g per 1 g of the anode catalyst. The obtained mixture was allowed to stand for 18 hours. The pH of the 5 M aqueous solution of formic acid was 0.9, and the proton concentration in the aqueous solution of formic acid was therefore about 0.13 mol/L.

Subsequently, filtration was conducted in the same manner as Example 1. The filtration was conducted in a glove box with an oxygen concentration of 5%, so that oxidation reaction of formic acid does not progress too rapidly. The solids filtered and removed were allowed to stand in the glove box for 12 hours after completing filtration, thus removing formic acid by oxidation. A second anode catalyst ink was prepared in the same manner as Example 1 by using the obtained solids as they were, not having been subjected to a water washing treatment. A DMFC was produced in the same manner as Example 1 by using the second anode catalyst ink. The obtained DMFC was designated as cell “C”.

### Comparative Example 1

A DMFC was produced in the same manner as Example 1, except for using the first anode catalyst ink produced in Example 1 as it was. The obtained DMFC was designated as comparative cell “R”.

### (Evaluation)

Evaluations were made on cells “A” to “C” and comparative cell “R” in three aspects, being the Ru leaching rate measurement, initial power generation characteristics, and long-term continuous power generation characteristics.

### (Ru Leaching Rate Measurement)

Ruthenium prone to leaching are considered to be already removed from the anode catalysts contained in cells “A” to “C”, respectively, by the fabrication method of the present invention. Due to the above, the respective leaching rates of ruthenium leached from the anode catalysts contained in cells “A” to “C”, respectively, are considered to be significantly reduced, compared to the leaching rate of ruthenium leached from an anode catalyst that is not subjected to the fabrication method of the present invention. In order to confirm the above, the leaching rate of ruthenium was measured under the following conditions.

First, the anode catalyst layer portion was separated from the MEA, and was dispersed in a predetermined amount of water. The proton-conductive ion-exchange resin used in Example 1 was added to the obtained dispersion liquid, so as to make the amount of the ion-exchange resin 5 g per 1 g of the anode catalyst.

The amount of the anode catalyst contained in the dispersion liquid was obtained from the composition ratio between the anode catalyst and the ion-exchanged resin in the anode catalyst layer, and the weight of the anode catalyst layer separated from the MEA.

Next, the dispersion liquid and a 1 M aqueous solution of sulfuric acid was mixed so as to make the amount of the aqueous solution of sulfuric acid about 0.1 g per 1 mg of the anode catalyst. The obtained mixture was allowed to stand for 12 hours. The mixture after standing was filtered, and the resulting filtrate was subjected to an ICP emission spectrometry to determine the ruthenium content in the filtrate. The leaching rate of ruthenium (per hour) per 1 mg of the anode catalyst was calculated from the obtained value.

### (Evaluation of Power Generation Characteristics)

### (i) Initial Power Generation Characteristics

A 2 mol/L aqueous methanol solution was used as fuel. Non-humidified air was used as the oxidant.

The temperature of each cell was controlled to be 60° C., by using a heating wire heater and a temperature controller. Each cell was connected to an electronic load device PLZ164WA (manufactured by Kikusui Electronics Corporation).

Fuel was supplied to the anode at a flow rate of 1 cm³/min, by using a tube-type pump. Non-humidified air was supplied to the cathode at a flow rate of 200 cm³/min with control conducted by a mass flow controller. Power generation was conducted at a constant current density of 200 mA/cm², and voltage was measured 1 minute after the start of power generation. The obtained values are shown in Table 1 as initial voltage.

### (ii) Long-term Continuous Power Generation Characteristics

Each cell was continuously operated for 1000 hours under the same condition as for the evaluation of initial power generation characteristics. For each cell, voltage was measured 1000 hours after the start of power generation. The obtained values are shown in Table 1 as voltages after long-term continuous operation.

TABLE 1

| | Leaching Rate of | Power Generation Characteristics | |
|---|---|---|---|
| | Ruthenium per 1 mg | Initial | Voltage after Long- |
| | of Anode Catalyst | Voltage | Term Continuous |
| | (μg/h) | (V) | Operation (V) |
| Cell A | 0.1 | 0.42 | 0.42 |
| Cell B | 0.2 | 0.41 | 0.41 |
| Cell C | 1.0 | 0.41 | 0.40 |
| Comp. Cell R | 3.9 | 0.35 | 0.24 |

As is evident from Table 1, cells “A” to “C” each exhibited initial voltages higher than that of comparative cell “R”, which were maintained even after long-term operation. That is, cells “A” to “C” exhibited excellent power generation characteristics.

The leaching rate of ruthenium increased in the order of cell “A”, cell “B”, cell “C”, and comparative cell “R”. On the other hand, the respective leaching rates of ruthenium leached from the anode catalysts contained in cells “A” to “C”, respectively, were shown in values significantly lower than the leaching rate of ruthenium leached from the anode catalyst contained in comparative cell “R”. That is, by the present invention, ruthenium was confirmed to be removed from the anode catalyst in advance.

When cells “A”, “B”, and “C” were compared, cell “A” had the smallest leaching amount of ruthenium. The anode catalyst of cell “A” is treated with acid, in a state of having a large ion-exchange resin amount relative to the anode catalyst amount. Due to the above, it is considered that acid strength near the anode catalyst increased, thus efficiently removing ruthenium prone to leaching.

Further, from the results of cells “A” to “C”, degradation in power generation performance was rarely seen in the case where the leaching rate of ruthenium was 1.0 μg/h or less per 1 mg of the anode catalyst. Thus, it was confirmed that the effects of the present invention were sufficiently obtained if the leaching rate of ruthenium was 1.0 μg/h or less per 1 mg of the anode catalyst.

As the above, the fuel cell produced by the fabrication method of the present invention was able to achieve high power generation performance and high continuous power generation performance, compared to a conventional fuel cell.

A fuel cell with high power generation performance and less performance degradation can be provided by the fabrication method of the present invention. Thus, the fuel cell produced by the fabrication method of the present invention can be suitably used as the power source for small portable electronic devices such as cell phones, PDAs, laptop computers, and video cameras. In addition, the fuel cell can be suitably used, also through application as the power source for electric scooters and the like.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A method for fabricating a fuel cell comprising a step of producing a unit cell, said step of producing a unit cell comprising a step of producing at least one unit cell comprising an anode including an anode catalyst layer containing an anode catalyst, a cathode including a cathode catalyst layer containing a cathode catalyst, and an electrolyte membrane interposed between said anode and said cathode,
wherein said step of producing a unit cell comprises a step (i) of immersing said anode catalyst in an acid-containing solution under the presence of a proton-conductive ion-exchange resin, the proton concentration in said acid-containing solution being 0.1 mol/L or more and 2 mol/L or less.

2. The method for fabricating a fuel cell in accordance with claim 1, wherein said anode catalyst is: an alloy of platinum and ruthenium; a mixture of an elementary platinum and an elementary ruthenium; or a mixture of an elementary platinum, a platinum-ruthenium alloy, and a ruthenium oxide.

3. The method for fabricating a fuel cell in accordance with claim 1, wherein said step (i) comprises steps of:
(i-A) mixing said anode catalyst and said proton-conductive ion-exchange resin with said acid-containing solution; and
(i-B) filtering and removing solids from the mixture obtained in said step (i-A).

4. The method for fabricating a fuel cell in accordance with claim 1, wherein said step (i) comprises steps of:
(I-a) preparing a catalyst ink comprising said anode catalyst and said proton-conductive ion-exchange resin;
(I-b) producing an anode catalyst layer using said catalyst ink; and
(I-c) immersing said anode catalyst layer in said acid-containing solution.

5. The method for fabricating a fuel cell in accordance with claim 3, further comprising a step of:
(ii) removing from said solids filtered and removed, anions originating from said acid.

6. The method for fabricating a fuel cell in accordance with claim 4, further comprising a step of:
(ii) removing from said anode catalyst layer after immersion, anions originating from said acid.

7. The method for fabricating a fuel cell according to claim 5, wherein said acid is sulfuric acid and said step of removing anions originating from said acid includes a water washing step.

8. The method for fabricating a fuel cell according to claim 6, wherein said acid is sulfuric acid and said step of removing anions originating from said acid includes a water washing step.

9. The method for fabricating a fuel cell according to claim 3, wherein the leaching amount of ruthenium from said anode catalyst per hour is 1 μm or less per 1 mg of said anode catalyst, when said anode catalyst after undergoing said step (i) is immersed in a mixture containing: 0.1 g or more of said proton-conductive ion-exchange resin per 1 g of said anode catalyst; and protons originating from said acid used in said step (i) at a concentration of 0.1 mol/L or more and 2 mol/L or less.

10. The method for fabricating a fuel cell according to claim 4, wherein the leaching amount of ruthenium from said anode catalyst per hour is 1 μm or less per 1 mg of said anode catalyst, when said anode catalyst after undergoing said step (i) is immersed in a mixture containing: 0.1 g or more of said proton-conductive ion-exchange resin per 1 g of said anode catalyst; and protons originating from said acid used in said step (i) at a concentration of 0.1 mol/L or more and 2 mol/L or less.

11. The method for fabricating a fuel cell according to claim 5, wherein the leaching amount of ruthenium from said anode catalyst per hour is 1 μm or less per 1 mg of said anode catalyst, when said anode catalyst after undergoing said step (ii) is immersed in a mixture containing: 0.1 g or more of said proton-conductive ion-exchange resin per 1 g of said anode catalyst; and protons originating from said acid used in said step (i) at a concentration of 0.1 mol/L or more and 2 mol/L or less.

12. The method for fabricating a fuel cell according to claim 6, wherein the leaching amount of ruthenium from said anode catalyst per hour is 1 μm or less per 1 mg of said anode catalyst, when said anode catalyst after undergoing said step (ii) is immersed in a mixture containing: 0.1 g or more of said proton-conductive ion-exchange resin per 1 g of said anode catalyst; and protons originating from said acid used in said step (i) at a concentration of 0.1 mol/L or more and 2 mol/L or less.

13. The method for fabricating a fuel cell according to claim 1, wherein said acid is an organic acid having no more than 2 carbon atoms.

14. The method for fabricating a fuel cell according to claim 13, wherein said organic acid having no more than 2 carbon atoms is formic acid.

15. The method for fabricating a fuel cell according to claim 1, wherein said proton-conductive ion-exchange resin contains a perfluorocarbonsulfonic acid polymer.

16. A method for fabricating an anode catalyst layer including an anode catalyst comprising a step of (i) immersing said anode catalyst in an acid-containing solution under the presence of a proton-conductive ion-exchange resin, the proton concentration in said acid-containing solution being 0.1 mol/L or more and 2 mol/L or less.
